(19) United States
(12) Patent Application Publication
(10) Pub. No.: US 2026/0082239 A1
(43) Pub. Date: Mar. 19, 2026

(54) ORCHESTRATING NETWORK SERVICE ACTIVITIES USING PREDICTED TRAFFIC

(71) Applicant: T-Mobile USA, Inc., Bellevue, WA (US)

(72) Inventors: Emile Minh Tran, Sammamish, WA (US); Antoine T. Tran, Bellevue, WA (US); Robert Andrew Berrier, Renton, WA (US); Luis Alberto Uribe Gonzalez, Parsippany, NJ (US); Venu GR Mudunuri, Carrollton, TX (US); Justin R. Mueller, Sammamish, WA (US)

(21) Appl. No.: 18/887,009

(22) Filed: Sep. 16, 2024

(51) Int. Cl. H04W 16/22; H04W 16/18

(52) U.S. Cl. CPC H04W 16/22; H04W 16/18

(57) ABSTRACT

Solutions are disclosed that orchestrate network service activities using predicted traffic in order to minimize service disruptions in a wireless network (e.g., cellular network), by preventing neighbor radio sites (e.g., cells or clusters) from becoming unavailable at the same time. This minimizes scenarios in which user equipment (UE) are left entirely without service for the duration of the network service activity. For example, when a serving radio site becomes unavailable, a UE may be handed over to a neighbor, without the neighbor also becoming unavailable. An orchestrator identifies a set of neighbor radio sites for which the network service activity is to be performed, generates a traffic prediction for each radio site, and selects the radio site and low traffic time in a manner that minimizes traffic disruptions, rotating the selection until all of the radio sites have been addressed. Different types of traffic and UEs may be weighted differently.

### BACKGROUND

Modern cellular networks typically require network service activities relatively often, such as upgrades (software and hardware), maintenance, and configuration changes, including frequency retuning when new spectrum becomes available. Even relatively quick network service activities may take a base station at a radio site (e.g., a cell site or cell cluster) offline for 10 to 30 minutes, during which time the radio site is unable to provide service to user equipment (UEs) in the vicinity. When a network service activity is performed on all or most radio sites in some market (e.g., the cellular coverage for a metropolitan area) UEs may find themselves in the middle of a “dead zone”, entirely without service, for the duration of a network service activity. This adversely affects usability and service reliability for large numbers of UEs.

### SUMMARY

The following summary is provided to illustrate examples disclosed herein, but is not meant to limit all examples to any particular configuration or sequence of operations.

Solutions are disclosed that orchestrate network service activities using predicted traffic in order to minimize service disruptions in a wireless network. Examples receive, by an orchestrator, an indication that a network service activity is to be performed for a first radio site of a plurality of radio sites within a geographic region; identify a set of radio sites including the first radio site and neighbor radio sites of the first radio site for which the network service activity is also to be performed, the neighbor radio sites having coverage zones overlapping with or adjacent to a coverage zone of the first radio site; generate a traffic prediction for each radio site of the set of radio sites; based on at least the traffic predictions, select a radio site from the set of radio sites for performing the network service activity, such that performing the network service activity for the selected radio site results in a lower predicted traffic disruption than performing the network service activity for a non-selected radio site of the set of radio sites; and perform the network service activity for the selected radio site.

### BRIEF DESCRIPTION OF THE DRAWINGS

The disclosed examples are described below with reference to the accompanying drawing figures listed below, wherein:

FIG. 1 illustrates an exemplary architecture that advantageously orchestrates network service activities using predicted traffic in order to minimize service disruptions;

FIG. 2 illustrates a plurality of radio sites (e.g., cells or cell clusters), as may exist in examples of the architecture of FIG. 1;

FIG. 3 illustrates examples of neighbor cells, as may occur in examples of the plurality of radio sites of FIG. 2;

FIG. 4 illustrates an exemplary plurality of radio sites for which a network service activity is required for at least one of the radio sites, as may occur in examples of the architecture of FIG. 1;

FIG. 5 illustrates network traffic prediction parameters, as may be used in examples of the architecture of FIG. 1;

FIG. 6 illustrates further detail for the example orchestrator of FIG. 1;

FIG. 7 illustrates an exemplary timeline of performing the network service activity in examples of the architecture of FIG. 1;

FIGS. 8 and 9 illustrate flowcharts of exemplary operations associated with the architecture of FIG. 1; and

FIG. 10 illustrates a block diagram of a computing device suitable for implementing various aspects of the disclosure.

Corresponding reference characters indicate corresponding parts throughout the drawings, where practical. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Solutions are disclosed that orchestrate network service activities using predicted traffic in order to minimize service disruptions in a wireless network (e.g., cellular network), by preventing neighbor radio sites (e.g., cells or clusters) from becoming unavailable at the same time. This minimizes scenarios in which user equipment (UE) are left entirely without service for the duration of the network service activity. For example, when a serving radio site becomes unavailable, a UE may be handed over to a neighbor, without the neighbor also becoming unavailable. An orchestrator identifies a set of neighbor radio sites for which the network service activity is to be performed, generates a traffic prediction for each radio site, and selects the radio site and low traffic time in a manner that minimizes traffic disruptions, rotating the selection until all of the radio sites have been addressed. Different types of traffic and UEs may be weighted differently. Applying this approach in parallel, while implementing the localized conflict restrictions, is able to schedules service activities at times that are selected for the lowest service impact across multiple sites of the wireless network.

Aspects of the disclosure thus improve the performance of wireless (cellular) networks by preventing neighbor radio sites (cells or cell clusters) from becoming unavailable at the same time, thus avoiding scenarios in which UEs are unable to receive service from any radio site the duration of the network service activity. This reduces negative impacts on a large number of network users. These advantageous results are accomplished, at least in part by, based on at least the traffic predictions, selecting a radio site from the set of radio sites for performing the network service activity, such that performing the network service activity for the selected radio site results in a lower predicted traffic disruption than performing the network service activity for a non-selected radio site of the set of radio sites.

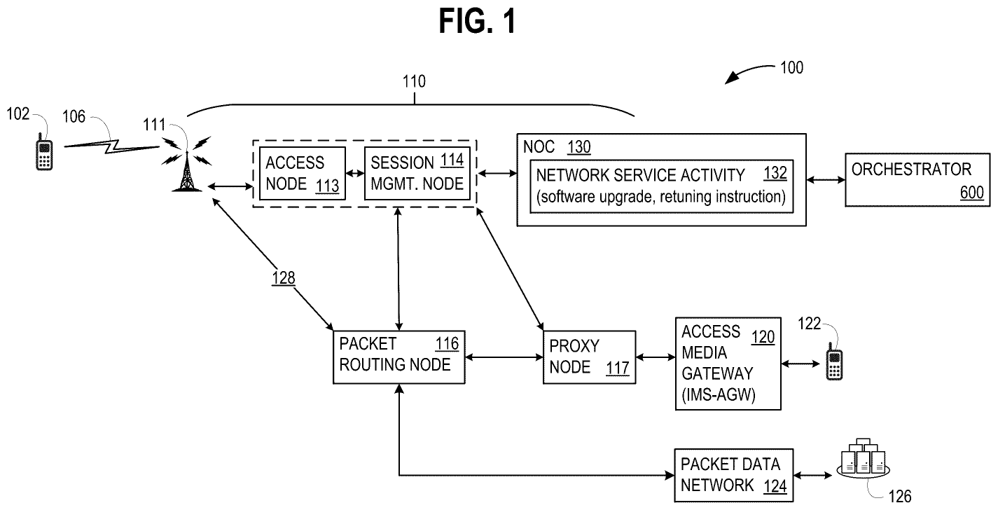

With reference now to the figures, FIG. 1 illustrates an exemplary architecture 100 that advantageously orchestrates network service activities using predicted traffic in order to minimize service disruptions. A wireless network 110 is illustrated that is serving a UE 102. UE 102 may be an enhanced Mobile Broadband (eMBB) or cellphone, a fixed wireless access (FWA), internet of things (IoT) device, machine-to-machine (M2M) communication device, a personal computer (PC, e.g., desktop, notebook, tablet, etc.) with a cellular modem, or another telecommunication devices capable of using a wireless network. In the scene depicted in FIG. 1, UE 102 is using wireless network 110 for a packet data session to reach a network resource 126 (e.g., a website) across an external packet data network 124 (e.g., the internet). In some scenarios, UE 102 may use wireless network 110 for a phone call with another UE 122. Wireless network 110 may be a cellular network such as a fifth generation (5G) network, a fourth generation (4G) network, or another cellular generation network. In some contexts, 5G is also referred to as new radio (NR), and standalone 5G, which is a full 5G implementation that does not rely on 4G technology for some functionality, may be referred to SA NR.

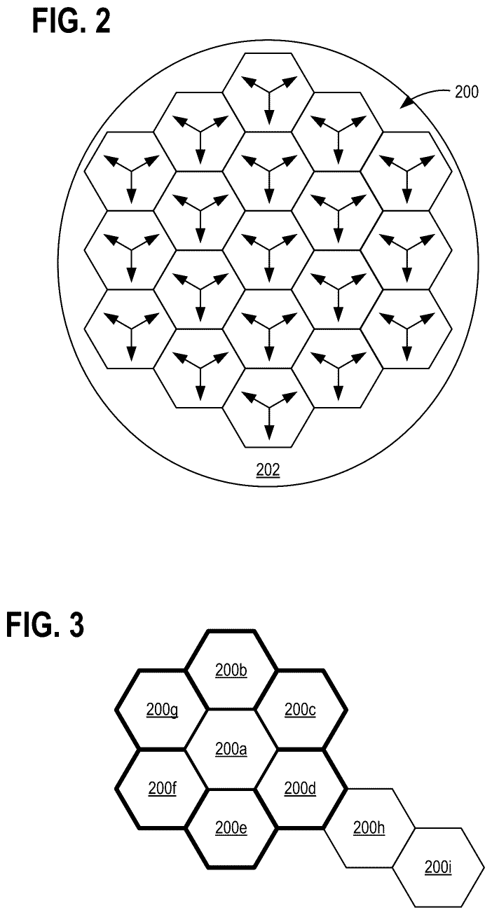

UE 102 uses an air interface 106 to communicate with a base station 111 of wireless network 110, such that base station 111 is the serving base station for UE 102 (providing the serving cell). In some scenarios, base station 111 may be referred to as a radio access network (RAN), and is located at a radio site (See FIG. 2). Wireless network 110 has an access node 113, a session management node 114, and other components (not shown). Wireless network 110 also has a packet routing node 116 and a proxy node 117. Access node 113 and session management node 114 are within a control plane of wireless network 110, and packet routing node 116 is within a data plane (a.k.a. user plane) of wireless network 110.

Base station 111 is in communication with access node 113 and packet routing node 116. Access node 113 is in communication with session management node 114, which is in communication with packet routing node 116 and proxy node 117. Packet routing node 116 is in communication with proxy node 117 and packet data network 124. In some 5G examples, base station 111 comprises a gNodeB (gNB), access node 113 comprises an access mobility function (AMF), session management node 114 comprises a session management function (SMF), and packet routing node 116 comprises a user plane function (UPF).

In some 4G examples, base station 111 comprises an eNodeB (eNB), access node 113 comprises a mobility management entity (MME), session management node 114 comprises a system architecture evolution gateway (SAEGW) control plane (SAEGW-C), and packet routing node 116 comprises an SAEGW-user plane (SAEGW-U). In some examples, proxy node 117 comprises a proxy call session control function (P-CSCF) in both 4G and 5G.

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, wireless network 110 may use both a gNB and an eNB co-located at a common cell site. In some examples, multiple cells may be co-located at a common cell site, and may be a mix of 5G and 4G.

Proxy node 117 is in communication with an internet protocol (IP) multimedia system (IMS) access gateway (IMS-AGW) 120 within an IMS, in order to provide connectivity to other wireless (cellular) networks, such as for a call with a UE 122 or a public switched telephone system (PSTN, also known as plain old telephone system, POTS). In some examples, proxy node 117 may be considered to be within the IMS. UE 102 reaches network resource 126 using packet data network 124 (or the IMS, in some examples). Data packets of data traffic 128 to/from UE 102 pass through at least base station 111 and packet routing node 116 on their way from/to packet data network 124 or IMS-AGW 120 (via proxy node 117).

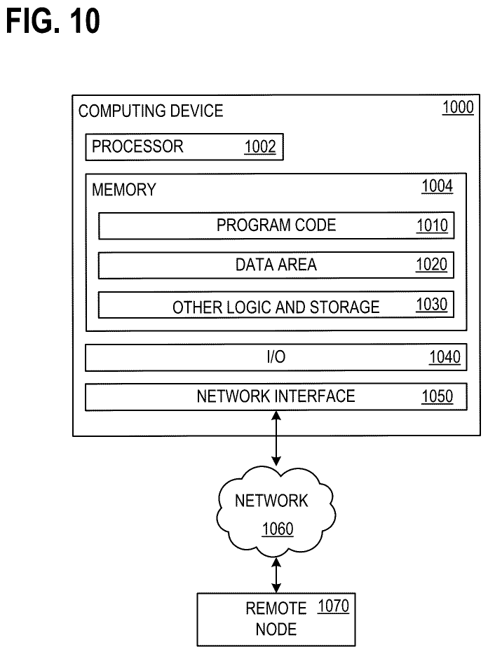

As described more fully below, in relation to the other figures, an orchestrator 600 schedules a network service activity 132 for nodes of wireless network 110, such as base station 111. Network service activity 132 may be an intangible abstraction in some examples (such as an activity of replacing equipment), but is represented in FIG. 1 as a tangible item such as a software upgrade package or frequency retuning instructions. Wireless network 110 has a network operations center 130 that may be involved in administering network service activity 132. In some examples, orchestrator 600 is provided as a remote computing service, such as a cloud service available over a computer network 1060 (see FIG. 10). In other examples, orchestrator 600 may run on a local computing resource.

Although FIG. 1 and some of the following figures are described using an example of a cellular network, it should be understood that the teachings herein are applicable to other types of wireless networks. To benefit from the teachings herein, another type of wireless network should offer geographically-dispersed radio sites with overlapping and/or adjacent coverage, such that a UE being served by one radio site may move over to being served by a neighboring radio site when the initially-serving radio site goes offline for a network service activity. With such a configuration, the teachings herein may extend to the other types of wireless network.

FIG. 2 illustrates a plurality of radio sites 200 in a geographic region 202. Plurality of radio sites 200 are the UE-facing portion of wireless network 110 within geographic region 202, and each radio site of plurality of radio sites 200 may contain one or more of base station 111. Performance of network service activity 132 may be limited to radio sites only within a single geographic region (or market, such as a metropolitan area) and/or under the control of one of possible multiple network managers within the geographic region at a time, in some scenarios.

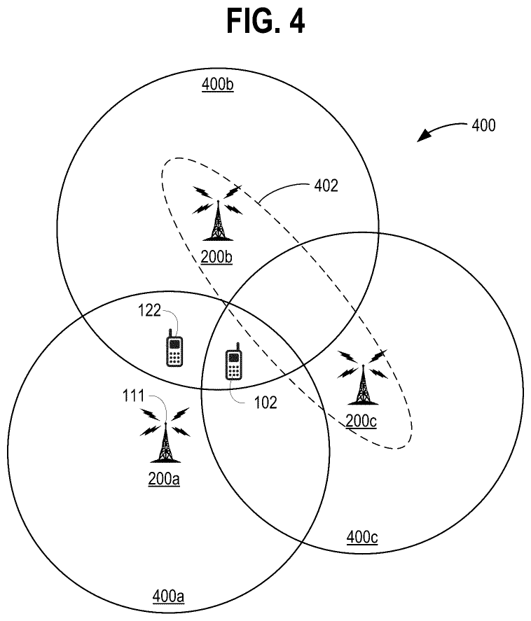

FIG. 3 illustrates a definition of tier 1 neighbors, using radio sites 200a-200i of radio sites 200. A central radio site 200a is surrounded by its tier 1 neighbors: a radio site 200b, a radio site 200c, a radio site 200d, a radio site 200e, a radio site 200f, and a radio site 200g - each of which is immediately adjacent to radio site 200a and thus has an adjacent coverage zone. Because radio sites 200b-200g are tier 1 neighbors of radio site 200a, a UE that is being served by radio site 200a may also have sufficient radio channel quality with one (or more) of radio sites 200b-200g to be served by that radio site when radio site 200a goes offline for network service activity 132. This is an overlapping coverage scenario. A supercell that has a coverage area overlapping with the coverage area of radio site 200a is another overlapping coverage scenario.

It is desirable that, when radio site 200a is scheduled for performance of network service activity 132, none of radio sites 200b-200g are also scheduled to begin performance of network service activity 132. Instead, performance of performance of network service activity 132 on one or more of radio sites 200b-200g should be contingent on completion of network service activity 132 on radio site 200a, and radio site 200a returning to servicing UEs. To provide a contrast to clarify the definition of tier 1 neighbor, a radio site 200h and a radio site 200i are not tier 1 neighbors of radio site 200a—although they are tier 1 neighbors of each other. Thus, it is likely acceptable for radio site 200h or radio site 200i (but not both) to be scheduled for performance of network service activity 132 simultaneously with radio site 200a.

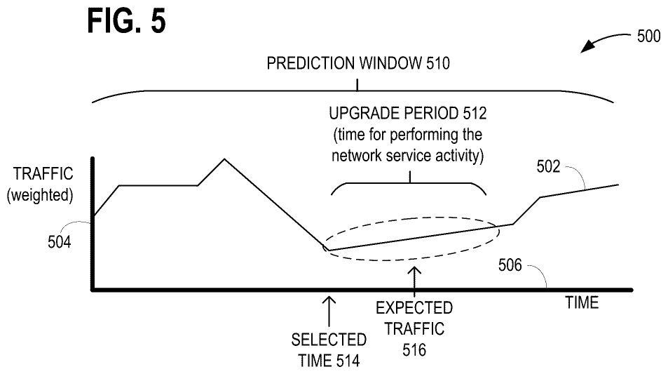

FIG. 4 illustrates an exemplary set of radio sites 400 that are all neighbor radio sites. That is radio sites 200b and 200c are neighbor radio sites 402 of radio site 200a. Radio site 200a has a coverage zone 400a, radio site 200b has a coverage zone 400b, and radio site 200c has a coverage zone 400c. As illustrated, coverage zones 400a, 400b, and 400c are both adjacent and overlap, at least to some extent. UE 102 is being served by base station 111 of radio site 200a. If radio site 200a becomes unavailable because network service activity 132 is being performed on base station 111 (i.e., being performed on radio site 200a), UE 102 is able to use either radio site 200b or radio site 200c.

In this illustrated scenario, UE 122 is being served by radio site 200b, and does not have coverage available from radio site 200c. If radio site 200b becomes unavailable while network service activity 132 is being performed on radio site 200a, UE 122 will lose coverage, disrupting network traffic. Thus, as explained below, orchestrator 600 will not schedule radio site 200b for network service activity 132 until network service activity 132 is completed for radio site 200a. At that point, if radio site 200b becomes unavailable while network service activity 132 is being performed, UE 122 will be able to use radio site 200a.

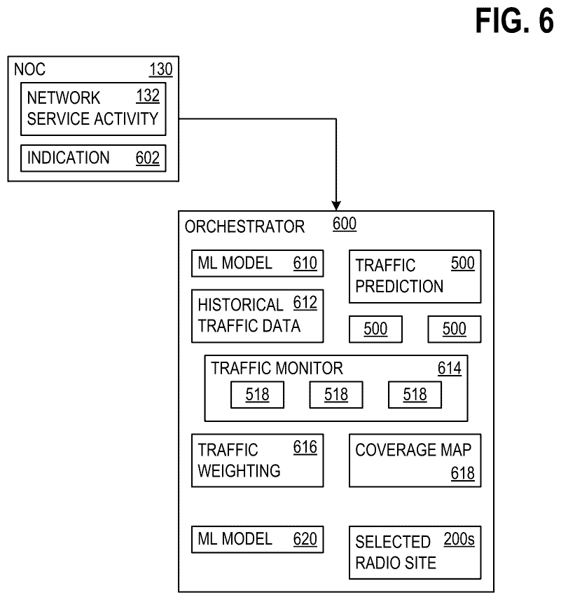

FIG. 5 illustrates a traffic prediction 500 that is performed for every radio site of set of radio sites 400 for which network service activity 132 is still needed. For illustration purposes, traffic 502 is shown in FIG. 5 plotted as a weighted traffic value 504 as a function of time 506, although actual examples of architecture 100 may instead merely determine traffic 502 as a vector of values. Traffic 502 may be weighted such that traffic for an FWA device is weighted differently than traffic for an eMBB device, traffic for an eMBB device having WiFi and/or WiFi calling available is weighted differently than traffic for an eMBB device not having WiFi access, and/or traffic for a UE having a prioritized network slice is weighted differently than traffic for a UE not having a prioritized network slice.

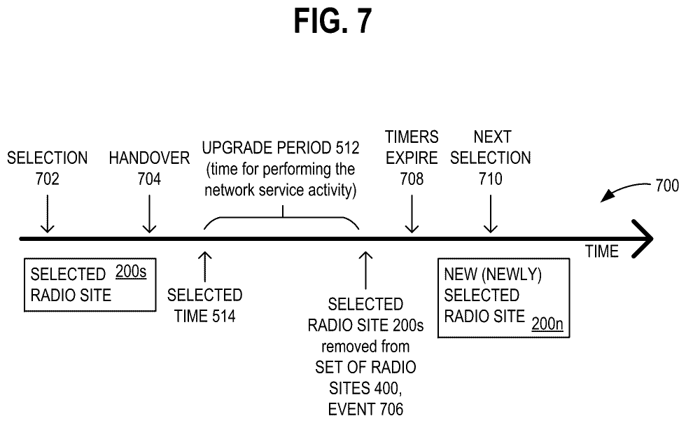

Traffic 502 is predicted for at least the duration of a prediction window 510, which may be one to four hours in duration, using historical traffic information (as explained in further detail in relation to FIG. 6). A selected time 514 is selected (for one radio site), in which expected traffic 516 for the duration of an upgrade period 512 is the lowest. This selection is made across all traffic predictions 500 that are made for every radio site of set of radio sites 400 for which network service activity 132 is still needed. This way, expected traffic 516 is the lowest of all radio sites for prediction window 510. Upgrade period 512 is the time that is required for performing network service activity 132. In some examples, this is for 20 or 30 minutes, up to two hours. This approach automatically takes into account differences between industrial, commercial, and residential areas, in which some have heavy daytime traffic (people are at work), but lesser evening and night time traffic (people go home), whereas others may have lesser daytime traffic and greater evening traffic (people come home from work and then go to sleep).

FIG. 6 illustrates further detail for aspects of architecture 100, such as orchestrator 600. Network operations center 130 sends an indication 602 to orchestrator 600 that radio site 200a (and other radio sites of wireless network 110) requires network service activity 132 to be performed. Orchestrator 600 identifies set of radio sites 400, which includes radio site 200a and neighbor radio sites 402 (i.e., radio sites 200b and 200c), using a coverage map 618.

A machine learning (ML) model 610 generates traffic prediction 500 for radio site 200a and other traffic predictions 500 for neighbor radio sites 402 using historical traffic data 612. ML is used herein interchangeably with artificial intelligence (AI). In some examples, traffic predictions are weighted according to traffic weighting 616 (as described above, in relation to FIG. 5, for weighting of traffic 502). A traffic monitor 614 determines current traffic 518 of each radio site in set of radio sites 400. In some examples, another ML model 620 is used to select a selected radio site 200s that minimizes (weighted) traffic disruptions, based on traffic predictions 500. Other examples may use an alternative selection scheme.

Selected radio site 200s may be any of radio sites 200a, 200b, or 200c, based on their respective traffic predictions 500.

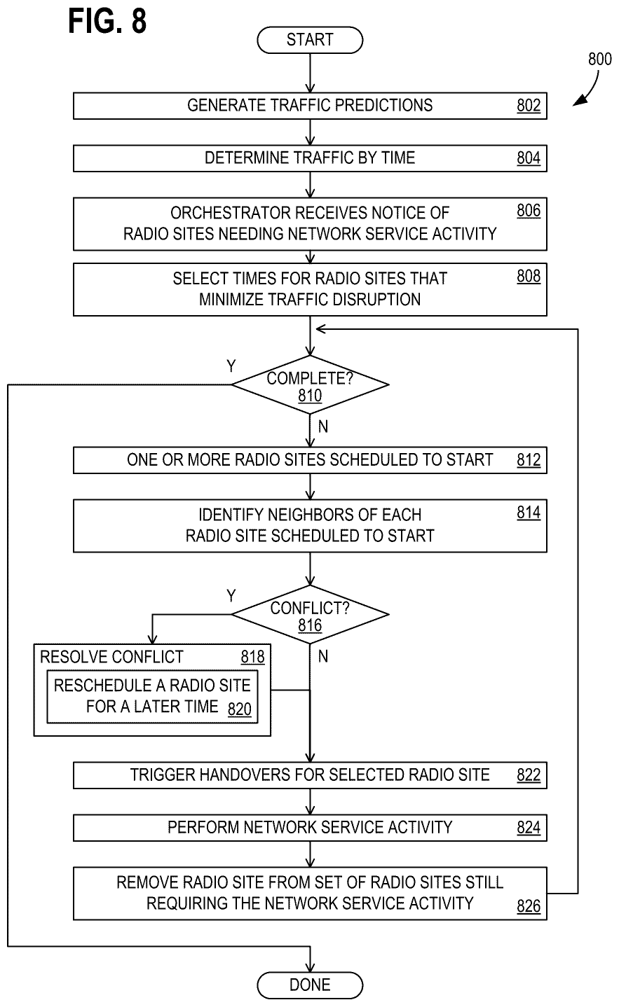

FIG. 7 illustrates an exemplary timeline 700 of performing network service activity 132. The selection of selected radio site 200s is performed at a selection event 702. Prior to taking selected radio site 200s offline to perform network service activity 132, a handover 704 is triggered for each UE currently using selected radio site 200s, and which has an alternate traffic solution available (e.g., another radio site or moving to WiFi, including WiFi calling). At selected time 514, network service activity 132 is started for selected radio site 200s. This lasts for the duration of upgrade period 512, which is the time for performing the network service activity 132. After the successful completion of network service activity 132, selected radio site 200s is removed from set of radio sites 400 at an event 706, shrinking the size of set of radio sites 400.

Any timers, used for delaying the start of the next radio site selection process, expire at expiration event 708, and a new radio site 200n (or newly selected radio site 200n) is selected from among the now smaller set of radio sites 400 at a selection event 710. New radio site 200n may be any of the radio sites remaining of radio sites 200a-200c. This continues until there are no radio sites remaining within set of radio sites 400, because network service activity 132 has been performed for all radio sites of the original set of radio sites 400.

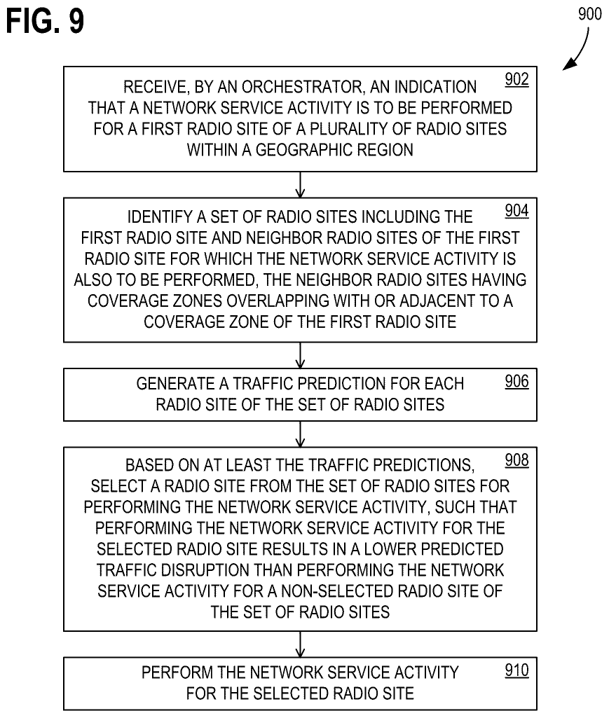

FIG. 8 illustrates a flowchart 800 of exemplary operations associated with architecture 100. In some examples, at least a portion of flowchart 800 may be performed using one or more computing devices 1000 of FIG. 10. Flowchart 800 commences with orchestrator 600 generating traffic prediction 500 for radio sites of wireless network 110 in operation 802. This includes each radio site of set of radio sites 400, and may be accomplished using ML. In some examples, traffic predictions 500 are weighted traffic predictions, based on UE type and/or traffic type. In operation 804, orchestrator 600 determines traffic 502 as a function of time within prediction window 510 (which also includes each radio site of set of radio sites 400).

In operation 806, orchestrator 600 receives indication 602, in operation 802, that network service activity 132 is to be performed for at least radio site 200a, and also for other radio sites of wireless network 110. Network service activity 132 may be any of: frequency retuning, a software upgrade, maintenance, and a hardware upgrade. Orchestrator 600 select times for radio sites (i.e., schedules radio sites) of wireless network 110 for performing network service activity 132, based on at least traffic predictions 500, in operation 808. This includes selecting radio site 200s.

Decision operation 810 determines whether any radio sites of wireless network 110 still require network service activity 132. In this first pass through flowchart 800, this will be a positive result, although when all radio sites have been addressed (i.e., network service activity 132 has been performed for all of them), flowchart 800 is complete and terminates.

Flowchart 800 cycles through operations 812-826, performing network service activity 132 in parallel for radio sites of wireless network 110 (although subject to the restriction of not taking out neighbor radio sites at the same time), while at least one radio site within wireless network 110 still requires network service activity 132. This includes the time period in which at least one radio site remains within set of radio sites 400.

Operation 812 identifies that one or more radio sites is scheduled to start performing network service activity 132, or is still in the process of network service activity 132. In operation 814, orchestrator 600 identifies set of radio sites 400, which includes radio site 200a and neighbor radio sites 402 of radio site 200a for which network service activity 132 is also still to be performed. Neighbor radio sites 402 have coverage zones 400b-400c overlapping with or adjacent to coverage zone 400a of radio site 200a, and may be tier 1 neighbors. Decision operation 816 determines whether two radio sites in set of radio sites 400 have a conflict, which is used here to mean that two (or more) radio sites of set of radio sites 400 are scheduled to begin network service activity 132, or a second one is scheduled to begin network service activity 132 while another is still in the process of network service activity 132.

If there is no conflict, flowchart 800 moves directly to operation 822. However, if there is a conflict, orchestrator 600 resolves the conflict in operation 818 by selecting selected radio site 200s from set of radio sites 400, based on at least traffic predictions 500, in operation 818. This selection is made, both selected radio site 200s and selected time 514 (the start time), such that performing network service activity 132 for selected radio site 200s at selected time 514 results in a lower predicted traffic disruption than performing network service activity 132 for a non-selected radio site of set of radio sites 400 (i.e., the other radio site having the conflict) and/or at a different time within prediction window 510. The non-selected radio site is rescheduled for network service activity 132 in operation 820, using least traffic prediction 500 for that radio site. Flowchart 800 then moves to operation 822.

However, prior to performing network service activity 132, orchestrator 600 triggers handover 704 for each UE being served by selected radio site 200s and having available coverage from another radio site (or WiFi, in some examples), in operation 822. Network service activity 132 is performed for selected radio site 200s as operation 824. Selected radio site 200s is removed from set of radio sites 400 in operation 826, reducing the size of set of radio sites 400. Flowchart 800 then returns to decision operation 810.

Iterating from decision operation 810 through operation 826 continues to selecting a new radio site 200n from set of radio sites 400 for performing network service activity 132, based on at least traffic predictions 500, performing network service activity 132 for newly selected radio site 200n, and removing newly selected radio site 200n from set of radio sites 400, until set of radio sites 400 is empty.

FIG. 9 illustrates a flowchart 900 of exemplary operations associated with examples of architecture 100. In some examples, at least a portion of flowchart 900 may be performed using one or more computing devices 1000 of FIG. 10. Flowchart 900 commences with operation 902, which includes receiving, by an orchestrator, an indication that a network service activity is to be performed for a first radio site of a plurality of radio sites within a geographic region.

Operation 904 includes identifying a set of radio sites including the first radio site and neighbor radio sites of the first radio site for which the network service activity is also to be performed, the neighbor radio sites having coverage zones overlapping with or adjacent to a coverage zone of the first radio site. Operation 906 includes generating a traffic prediction for each radio site of the set of radio sites.

Operation 908 includes based on at least the traffic predictions, selecting a radio site from the set of radio sites for performing the network service activity, such that performing the network service activity for the selected radio site results in a lower predicted traffic disruption than performing the network service activity for a non-selected radio site of the set of radio sites. Operation 910 includes performing the network service activity for the selected radio site.

FIG. 10 illustrates a block diagram of computing device 1000 that may be used as any component described herein that may require computational or storage capacity.

Computing device 1000 has at least a processor 1002 and a memory 1004 that holds program code 1010, data area 1020, and other logic and storage 1030. Memory 1004 is any device allowing information, such as computer executable instructions and/or other data, to be stored and retrieved. For example, memory 1004 may include one or more random access memory (RAM) modules, flash memory modules, hard disks, solid-state disks, persistent memory devices, and/or optical disks. Program code 1010 comprises computer executable instructions and computer executable components including instructions used to perform operations described herein. Data area 1020 holds data used to perform operations described herein. Memory 1004 also includes other logic and storage 1030 that performs or facilitates other functions disclosed herein or otherwise required of computing device 1000. An input/output (I/O) component 1040 facilitates receiving input from users and other devices and generating displays for users and outputs for other devices. A network interface 1050 permits communication over external computer network 1060 with a remote node 1070, which may represent another implementation of computing device 1000. For example, a remote node 1070 may represent another of the above-noted nodes within architecture 100.

### Additional Examples

An example system comprises: a processor; and a computer-readable medium storing instructions that are operative upon execution by the processor to: receive, by an orchestrator, an indication that a network service activity is to be performed for a first radio site of a plurality of radio sites within a geographic region; identify a set of radio sites including the first radio site and neighbor radio sites of the first radio site for which the network service activity is also to be performed, the neighbor radio sites having coverage zones overlapping with or adjacent to a coverage zone of the first radio site; generate a traffic prediction for each radio site of the set of radio sites; based on at least the traffic predictions, select a radio site from the set of radio sites for performing the network service activity, such that performing the network service activity for the selected radio site results in a lower predicted traffic disruption than performing the network service activity for a non-selected radio site of the set of radio sites; and perform the network service activity for the selected radio site.

An example method comprises: receiving, by an orchestrator, an indication that a network service activity is to be performed for a first radio site of a plurality of radio sites within a geographic region; identifying a set of radio sites including the first radio site and neighbor radio sites of the first radio site for which the network service activity is also to be performed, the neighbor radio sites having coverage zones overlapping with or adjacent to a coverage zone of the first radio site; generating a traffic prediction for each radio site of the set of radio sites; based on at least the traffic predictions, selecting a radio site from the set of radio sites for performing the network service activity, such that performing the network service activity for the selected radio site results in a lower predicted traffic disruption than performing the network service activity for a non-selected radio site of the set of radio sites; and performing the network service activity for the selected radio site.

One or more example computer storage devices has computer-executable instructions stored thereon, which, upon execution by a computer, cause the computer to perform operations comprising: receiving, by an orchestrator, an indication that a network service activity is to be performed for a first radio site of a plurality of radio sites within a geographic region; identifying a set of radio sites including the first radio site and neighbor radio sites of the first radio site for which the network service activity is also to be performed, the neighbor radio sites having coverage zones overlapping with or adjacent to a coverage zone of the first radio site; generating a traffic prediction for each radio site of the set of radio sites; based on at least the traffic predictions, selecting a radio site from the set of radio sites for performing the network service activity, such that performing the network service activity for the selected radio site results in a lower predicted traffic disruption than performing the network service activity for a non-selected radio site of the set of radio sites; and performing the network service activity for the selected radio site.

Alternatively, or in addition to the other examples described herein, examples include any combination of the following:
the wireless network comprises a cellular network;
the radio sites comprise cell sites or cell clusters;
the network service activity comprises an activity selected from the list consisting of: frequency retuning, a software upgrade, maintenance, and a hardware upgrade;
determining, for each radio site of the set of radio sites, traffic as a function of time within a prediction window;
selecting the radio site from the set of radio sites further comprises selecting a time for performing the network service activity, such that performing the network service activity for the selected radio site at the selected time results in a lower predicted traffic disruption than performing the network service activity for a non-selected radio site of the set of radio sites and/or at a different time within the prediction window;
prior to performing the network service activity, triggering a handover for each UE being served by the selected radio site and having available coverage from another radio site;
prior to selecting the radio site, adjusting the traffic prediction, for each radio site of the set of radio sites, using current traffic of the radio site;
removing the selected radio site from the set of radio sites;
iterating generating traffic predictions, selecting a new radio site from the set of radio sites for performing the network service activity based on at least the traffic predictions, performing the network service activity for the newly selected radio site, and removing the newly selected radio site from the set of radio sites until the set of radio sites is empty;
the traffic predictions are weighted traffic predictions;
traffic for an FWA device is weighted differently than traffic for an eMBB device;
traffic for an eMBB device having WiFi and/or WiFi calling available is weighted differently than traffic for an eMBB device not having WiFi access;
traffic for a UE having a prioritized network slice is weighted differently than traffic for a UE not having a prioritized network slice;
the first radio site receives the instruction that the network service activity is to be performed;
the first radio site alerts the orchestrator that the network service activity is to be performed;
the neighbor radio sites comprise tier 1 neighbors;
generating the traffic predictions using ML; and
the prediction window is one to four hours.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method of performing maintenance on a wireless network, the method comprising:
receiving, by an orchestrator, an indication that a network service activity is to be performed for a first radio site of a plurality of radio sites within a geographic region;
identifying a set of radio sites including the first radio site and neighbor radio sites of the first radio site for which the network service activity is also to be performed, the neighbor radio sites having coverage zones overlapping with or adjacent to a coverage zone of the first radio site;
generating a traffic prediction for each radio site of the set of radio sites;
based on at least the traffic predictions, selecting a radio site from the set of radio sites for performing the network service activity, such that performing the network service activity for the selected radio site results in a lower predicted traffic disruption than performing the network service activity for a non-selected radio site of the set of radio sites; and
performing the network service activity for the selected radio site.

2. The method of claim 1, further comprising:
determining, for each radio site of the set of radio sites, traffic as a function of time within a prediction window, wherein selecting the radio site from the set of radio sites further comprises selecting a time for performing the network service activity, such that performing the network service activity for the selected radio site at the selected time results in a lower predicted traffic disruption than performing the network service activity for a non-selected radio site of the set of radio sites and/or at a different time within the prediction window.

3. The method of claim 1, further comprising:
prior to performing the network service activity, triggering a handover for each user equipment (UE) being served by the selected radio site and having available coverage from another radio site.

4. The method of claim 1, further comprising:
prior to selecting the radio site, adjusting the traffic prediction, for each radio site of the set of radio sites, using current traffic of the radio site.

5. The method of claim 1, further comprising:
removing the selected radio site from the set of radio sites; and
iterating generating traffic predictions, selecting a new radio site from the set of radio sites for performing the network service activity based on at least the traffic predictions, performing the network service activity for the newly selected radio site, and removing the newly selected radio site from the set of radio sites until the set of radio sites is empty.

6. The method of claim 1, wherein the network service activity comprises an activity selected from the list consisting of:
frequency retuning, a software upgrade, maintenance, and a hardware upgrade.

7. The method of claim 1, wherein the traffic predictions are weighted traffic predictions, and wherein:
traffic for a fixed wireless access (FWA) device is weighted differently than traffic for an enhanced mobile broadband (eMBB) device; or
traffic for an eMBB device having WiFi and/or WiFi calling available is weighted differently than traffic for an eMBB device not having WiFi access; or
traffic for a user equipment (UE) having a prioritized network slice is weighted differently than traffic for a UE not having a prioritized network slice.

8. A system comprising:
a processor; and
a computer-readable medium storing instructions that are operative upon execution by the processor to:
receive, by an orchestrator, an indication that a network service activity is to be performed for a first radio site of a plurality of radio sites within a geographic region;
identify a set of radio sites including the first radio site and neighbor radio sites of the first radio site for which the network service activity is also to be performed, the neighbor radio sites having coverage zones overlapping with or adjacent to a coverage zone of the first radio site;
generate a traffic prediction for each radio site of the set of radio sites;
based on at least the traffic predictions, select a radio site from the set of radio sites for performing the network service activity, such that performing the network service activity for the selected radio site results in a lower predicted traffic disruption than performing the network service activity for a non-selected radio site of the set of radio sites; and
perform the network service activity for the selected radio site.

9. The system of claim 8, wherein the instructions are further operative to:
determine, for each radio site of the set of radio sites, traffic as a function of time within a prediction window, wherein selecting the radio site from the set of radio sites further comprises selecting a time for performing the network service activity, such that performing the network service activity for the selected radio site at the selected time results in a lower predicted traffic disruption than performing the network service activity for a non-selected radio site of the set of radio sites and/or at a different time within the prediction window.

10. The system of claim 8, wherein the instructions are further operative to:
prior to performing the network service activity, trigger a handover for each user equipment (UE) being served by the selected radio site and having available coverage from another radio site.

11. The system of claim 8, wherein the instructions are further operative to:
prior to selecting the radio site, adjust the traffic prediction, for each radio site of the set of radio sites, using current traffic of the radio site.

12. The system of claim 8, wherein the instructions are further operative to:
remove the selected radio site from the set of radio sites; and
iterate generating traffic predictions, selecting a new radio site from the set of radio sites for performing the network service activity based on at least the traffic predictions, performing the network service activity for the newly selected radio site, and removing the newly selected radio site from the set of radio sites until the set of radio sites is empty.

13. The system of claim 8, wherein the network service activity comprises an activity selected from the list consisting of:
frequency retuning, a software upgrade, maintenance, and a hardware upgrade.

14. The system of claim 8, wherein the traffic predictions are weighted traffic predictions, and wherein:
traffic for a fixed wireless access (FWA) device is weighted differently than traffic for an enhanced mobile broadband (eMBB) device; or
traffic for an eMBB device having WiFi and/or WiFi calling available is weighted differently than traffic for an eMBB device not having WiFi access; or
traffic for a user equipment (UE) having a prioritized network slice is weighted differently than traffic for a UE not having a prioritized network slice.

15. One or more computer storage devices having computer-executable instructions stored thereon, which, upon execution by a computer, cause the computer to perform operations comprising:
receiving, by an orchestrator, an indication that a network service activity is to be performed for a first radio site of a plurality of radio sites within a geographic region;
identifying a set of radio sites including the first radio site and neighbor radio sites of the first radio site for which the network service activity is also to be performed, the neighbor radio sites having coverage zones overlapping with or adjacent to a coverage zone of the first radio site;
generating a traffic prediction for each radio site of the set of radio sites;
based on at least the traffic predictions, selecting a radio site from the set of radio sites for performing the network service activity, such that performing the network service activity for the selected radio site results in a lower predicted traffic disruption than performing the network service activity for a non-selected radio site of the set of radio sites; and
performing the network service activity for the selected radio site.

16. The one or more computer storage devices of claim 15, wherein the operations further comprise:
determining, for each radio site of the set of radio sites, traffic as a function of time within a prediction window, wherein selecting the radio site from the set of radio sites further comprises selecting a time for performing the network service activity, such that performing the network service activity for the selected radio site at the selected time results in a lower predicted traffic disruption than performing the network service activity for a non-selected radio site of the set of radio sites and/or at a different time within the prediction window.

17. The one or more computer storage devices of claim 15, wherein the operations further comprise:
prior to performing the network service activity, triggering a handover for each user equipment (UE) being served by the selected radio site and having available coverage from another radio site.

18. The one or more computer storage devices of claim 15, wherein the operations further comprise:
prior to selecting the radio site, adjusting the traffic prediction, for each radio site of the set of radio sites, using current traffic of the radio site.

19. The one or more computer storage devices of claim 15, wherein the operations further comprise:
removing the selected radio site from the set of radio sites; and
iterating generating traffic predictions, selecting a new radio site from the set of radio sites for performing the network service activity based on at least the traffic predictions, performing the network service activity for the newly selected radio site, and removing the newly selected radio site from the set of radio sites until the set of radio sites is empty.

20. The one or more computer storage devices of claim 15, wherein the network service activity comprises an activity selected from the list consisting of:
frequency retuning, a software upgrade, maintenance, and a hardware upgrade.
